(19) United States
(12) Patent Application Publication
(10) Pub. No.: US 2026/0209448 A1
(43) Pub. Date: Jul. 23, 2026

(54) ELASTOMER COMPOSITIONS COMPRISING A PYROLYSIS CARBON BLACK

(71) Applicant: COMPAGNIE GENERALE DES ETABLISSEMENTS MICHELIN, Clermont-Ferrand (FR)

(72) Inventor: ETIENNE FLEURY, Clermont-Ferrand (FR)

(21) Appl. No.: 19/140,487

(22) PCT Filed: Dec. 19, 2023
(86) PCT No.: PCT/FR2023/052060

§ 371 Date: Jun. 18, 2025

(30) Foreign Application Priority Data
Dec. 21, 2022 (FR) FR2214060

(51) Int. Cl. C08J 3/24; B60C 1/00; B60C 11/00; C08F 8/00; C08K 3/04

(52) U.S. Cl. CPC C08J 3/24; B60C 1/0016; B60C 11/0008; C08F 8/00; C08K 3/04; B60C 2011/0025; C08F 2800/10; C08F 2810/20; C08J 2323/08

(57) ABSTRACT

The present disclosure relates to an elastomer composition based on:
at least one highly saturated diene elastomer, the highly saturated diene elastomer being a copolymer of ethylene and of a 1,3-diene containing ethylene units which represent at least 50 mol % of the monomer units of the copolymer,
a reinforcing filler comprising at least one pyrolysis carbon black; and
a crosslinking system.

### FIELD OF THE INVENTION

The present invention relates to the field of reinforced elastomer compositions which are in particular intended for the manufacture of rubber articles, such as in particular semi-finished articles for pneumatic tyres or non-pneumatic tyres, in particular for vehicles carrying heavy loads.

### TECHNOLOGICAL BACKGROUND

Ideally, the elastomer compositions that constitute pneumatic or non-pneumatic tyre treads must fulfil a great many technical requirements, which are often contradictory in nature, including increased wear resistance while affording the tyre low rolling resistance.

In order to increase the stiffness of an elastomer composition it is known, for example, to increase the content of reinforcing fillers. However, this solution has the disadvantage of increasing the hysteresis of the elastomer composition.

Moreover, in recent years, limiting the environmental impact of the manufacturing and use of tyres has become a major challenge for the manufacturers in the sector.

Research and development initiatives for producing tyres based on recycled materials have increased in number. For example, it has been proposed to employ pyrolysis carbon blacks as a total or partial substitution for conventional tyre-grade carbon blacks used as reinforcing filler in the elastomer compositions which constitute the tyre, in particular the treads. While this solution offers gains in hysteresis (rolling resistance), these gains come at the cost of reduced stiffness, which is reflected in reduced wear resistance of the tyres.

The loss of stiffness observed when using pyrolysis carbon blacks can in particular be compensated for by increasing the content of reinforcing filler in the elastomer compositions. However, this increase in the content of reinforcing fillers gives rise to an increase in the hysteresis of the composition and thus a risk of adversely affecting the rolling resistance properties, in particular of a pneumatic or non-pneumatic tyre tread.

There is therefore still a need to provide elastomer compositions that reduce the environmental impact by incorporating recycled materials and that fulfil a stiffness/hysteresis balance while maintaining other properties, it being possible for these compositions to be most particularly used to form all or part of the tread of a pneumatic or non-pneumatic tyre tread.

### BRIEF DESCRIPTION OF THE INVENTION

The present invention relates to an elastomer composition based on:
at least one highly saturated diene elastomer, the highly saturated diene elastomer being a copolymer of ethylene and of a 1,3-diene containing ethylene units which represent at least 50 mol % of the monomer units of the copolymer;
a reinforcing filler comprising at least one pyrolysis carbon black; and
a crosslinking system.

The present invention also relates to a rubber article comprising at least one such elastomer composition, the article preferably being selected from the group consisting of hoses, tubing, gaskets, O-rings, transmission belts, engine supports, electric cable insulators, shoe soles, semi-finished articles for pneumatic tyres, semi-finished articles for non-pneumatic tyres, non-pneumatic tyres and pneumatic tyres.

Other aspects of the invention are as described below and in the claims.

### Definitions

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the noncrosslinked state.

The expression “part by weight per hundred parts by weight of elastomer” (or phr) should be understood as meaning the part by mass per hundred parts by mass of elastomer or of rubber, the two terms being synonymous.

In the present document, unless expressly indicated otherwise, all the percentages (%) indicated are percentages (%) by mass.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b).

The compounds mentioned in the description may be of fossil origin or may be biobased. In the latter case, they may be partially or totally derived from biomass or obtained from renewable raw materials derived from biomass. This particularly concerns polymers, plasticizers, fillers, etc.

The term “tyre intended to equip a vehicle carrying heavy loads” is understood generically to mean any tyre equipping heavy-goods vehicles, vans, underground trains, buses, civil engineering vehicles, agricultural vehicles, aircraft and other handling vehicles.

The term “elastomer matrix” or “elastomeric matrix” means all of the elastomer(s) present in the elastomer composition.

Within the meaning of the present invention, the term “predominantly” means that the compound is predominant among the compounds of the same type in the composition, that is to say that it is the one which represents the greatest amount by mass among the compounds of the same type. In other words, the mass of this compound represents at least 51% of the total mass of the compounds of the same type in the composition. By way of example, in a system comprising just one elastomer, the latter is predominant within the meaning of the present invention, and in a system comprising two elastomers, the predominant elastomer represents more than half of the total mass of the elastomers, in other words the mass of this elastomer represents at least 51% of the total mass of the elastomers. Likewise, a “predominant” filler is the one representing the greatest mass among the fillers of the composition. In other words, the mass of this filler represents at least 51% of the total mass of the fillers in the composition.

All the values for glass transition temperature “Tg” are measured in a known manner by DSC (Differential Scanning Calorimetry) according to Standard ASTM D3418 (2008). Unless otherwise indicated, the contents of a monomer unit or repeating sub-unit in the highly saturated diene elastomer are given as molar percentages calculated on the basis of all of the monomer units of the elastomer. The term “all of the monomer units of the elastomer” means all the constituent repeating units of the elastomer which result from the insertion of the monomers into the elastomer chain by polymerization.

### DETAILED DESCRIPTION OF THE INVENTION

Surprisingly, the inventors have discovered that the specific combination of at least one highly saturated diene elastomer as described below and a reinforcing filler as described below and a crosslinking system makes it possible to obtain an elastomer composition that meets the stated needs.

In particular, the elastomer composition can be used in a pneumatic or non-pneumatic tyre, in particular in a tread for a pneumatic or non-pneumatic tyre equipping vehicles carrying heavy loads. The proposed solution makes it possible to reduce the environmental impact of the tyres by incorporating recycled materials, and makes it possible to obtain a good stiffness/hysteresis (wear resistance/rolling resistance) balance.

Thus, the present invention relates to an elastomer composition based on:
at least one highly saturated diene elastomer, the highly saturated diene elastomer being a copolymer of ethylene and of a 1,3-diene containing ethylene units which represent at least 50 mol % of the monomer units of the copolymer;
a reinforcing filler comprising at least one pyrolysis carbon black; and
a crosslinking system.

The present invention also relates to a rubber article comprising at least one such elastomer composition, the article preferably being selected from the group consisting of hoses, tubing, gaskets, O-rings, transmission belts, engine supports, electric cable insulators, shoe soles, semi-finished articles for pneumatic tyres, semi-finished articles for non-pneumatic tyres, non-pneumatic tyres and pneumatic tyres.

Other aspects of the invention are as described below and in the claims.

### Highly Saturated Diene Elastomer

The elastomer composition of use in the context of the present invention comprises at least one preferably random highly saturated diene elastomer (i.e. one or more highly saturated diene elastomers), the highly saturated diene elastomer being a copolymer of 1,3-diene units and of ethylene units, the ethylene units representing at least 50 mol % of the monomer units of the copolymer.

In the remainder of the present description, the expression “highly saturated diene elastomer being a copolymer of 1,3-diene units and of ethylene units, the ethylene units representing at least 50 mol % of the monomer units of the copolymer”.

In a known manner, the expression “ethylene unit” refers to the —(CH₂—CH₂)— sub-unit resulting from the insertion of ethylene into the elastomer chain. The highly saturated diene elastomer is rich in ethylene units, since the ethylene units represent at least 50 mol % of all of the monomer units of the elastomer.

Unless otherwise indicated, the contents of the units resulting from the insertion of a monomer into a copolymer such as the copolymer of use in the invention are expressed as molar percentage relative to all of the monomer units of the copolymer.

Preferably, the highly saturated diene elastomer is a random copolymer.

Preferably, the highly saturated diene elastomer comprises at least 55 mol % of ethylene units, preferentially at least 60 mol % of ethylene units, more preferentially at least 65 mol % of ethylene units. In other words, the ethylene units in the highly saturated diene elastomer preferentially represent at least 55 mol % of all of the monomer units of the highly saturated diene elastomer, more preferentially at least 60 mol % of all of the monomer units of the highly saturated diene elastomer. More preferentially still, the ethylene units represent at least 65 mol % of all of the monomer units of the highly saturated diene elastomer.

Preferably, the ethylene units in the highly saturated diene elastomer represent at most 90 mol % of all of the monomer units of the highly saturated diene elastomer. More preferentially, the ethylene units represent at most 85 mol % of all of the monomer units of the highly saturated diene elastomer. More preferentially still, the ethylene units represent at most 80 mol % of all of the monomer units of the highly saturated diene elastomer.

According to one advantageous embodiment, the highly saturated diene elastomer comprises from 55 mol % to 90 mol % of ethylene units, particularly from 55 mol % to 85 mol % of ethylene units, the molar percentage being calculated on the basis of all of the monomer units of the highly saturated diene elastomer. More advantageously, the highly saturated diene elastomer comprises from 55 mol % to 80 mol % of ethylene units, the molar percentage being calculated on the basis of all of the monomer units of the highly saturated diene elastomer.

According to another advantageous embodiment, the highly saturated diene elastomer comprises from 60 mol % to 90 mol % of ethylene units, particularly from 60 mol % to 85 mol % of ethylene units, the molar percentage being calculated on the basis of all of the monomer units of the highly saturated diene elastomer. More advantageously, the highly saturated diene elastomer comprises from 60 mol % to 80 mol % of ethylene units, the molar percentage being calculated on the basis of all of the monomer units of the highly saturated diene elastomer.

According to yet another advantageous embodiment, the highly saturated diene elastomer comprises from 65 mol % to 90 mol % of ethylene units, particularly from 65 mol % to 85 mol % of ethylene units, the molar percentage being calculated on the basis of all of the monomer units of the highly saturated diene elastomer.

More advantageously, the highly saturated diene elastomer comprises from 65 mol % to 80 mol % of ethylene units, the molar percentage being calculated on the basis of all of the monomer units of the highly saturated diene elastomer.

Since the highly saturated diene elastomer is a copolymer of ethylene and of a 1,3-diene, it also comprises 1,3-diene units resulting from the polymerization of a 1,3-diene. In a known manner, the expression “1,3-diene unit” refers to units resulting from the insertion of 1,3-diene via a 1,4 addition, a 1,2 addition or a 3,4 addition in the case of isoprene, for example.

Preferably, the 1,3-diene is 1,3-butadiene or a mixture of 1,3-dienes, one of which is 1,3-butadiene. More preferentially, the 1,3-diene is 1,3-butadiene, in which case the highly saturated diene elastomer is a preferably random copolymer of ethylene and of 1,3-butadiene.

The highly saturated diene elastomer preferably contains units of formula (I) and/or units of formula (II):

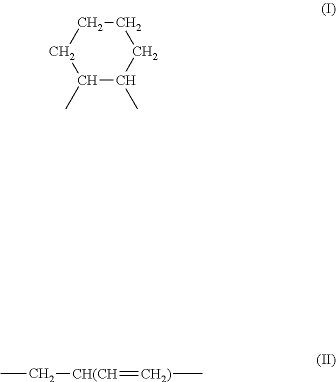

For example, the copolymer of ethylene and of 1,3-diene may be free of units of formula (I). In this case, it preferably contains units of formula (II).

The presence of a saturated 6-membered ring sub-unit, the 1,2-cyclohexanediyl sub-unit, of formula (I) as a monomer unit in the copolymer may result from a series of very specific insertions of ethylene and of 1,3-butadiene into the polymer chain during its growth. When the highly saturated diene elastomer comprises units of formula (I) or units of formula (II) or else units of formula (I) and units of formula (II) in the copolymer, the molar percentages of units of formula (I) and of units of formula (II) in the copolymer, respectively o and p, preferably satisfy the following equation (eq. 1), or the equation (eq. 2), o and p being calculated on the basis of all the monomer units of the highly saturated diene elastomer:

$$0 < o + p \leq 30 \qquad ( eq . 1 )$$

$$0 < o + p < 25. \qquad ( eq . 2 )$$

Preferably, the highly saturated diene elastomer comprises units of formula (I) at a molar content greater than 0 mol % and less than 15 mol %, more preferentially less than 10 mol %, the molar percentage being calculated on the basis of all of the monomer units of the highly saturated diene elastomer.

According to a particularly preferential embodiment, the highly saturated diene elastomer contains 1,4 units of trans configuration (1,4-trans units). When the diene elastomer contains 1,4-trans units, the 1,4-trans units represent more than 50 mol % of the 1,4 units of the highly saturated diene elastomer, preferentially more than 80 mol % of the 1,4 units of the highly saturated diene elastomer.

The highly saturated diene elastomer of use for the purposes of the invention may consist of a mixture of highly saturated diene elastomers which differ from each other in their microstructures or in their macrostructures.

The highly saturated diene elastomer can be obtained according to various synthesis methods known to those skilled in the art, in particular on the basis of the targeted microstructure of the highly saturated diene elastomer. Generally, it can be prepared by copolymerization at least of a 1,3-diene, preferably 1,3-butadiene, and of ethylene, and according to known synthesis methods, in particular in the presence of a catalytic system comprising a metallocene complex. Mention may be made in this regard of catalytic systems based on metallocene complexes, which catalytic systems are described in documents EP 1 092 731, WO 2004/035639, WO 2007/054223 and WO 2007/054224 in the name of the applicant. The highly saturated diene elastomer, including when it is random, can also be prepared by a process using a catalytic system of preformed type, such as those described in the documents WO 2017/093654 A1, WO 2018/020122 A1 and WO 2018/020123 A1. Advantageously, the highly saturated diene elastomer is random and is preferentially prepared according to a semi-continuous or continuous process, such as described in documents WO 2017/103543 A1, WO 2017/13544 A1, WO 2018/193193 and WO 2018/193194.

Preferably, the content of the highly saturated diene elastomer in the elastomer composition of use in the context of the invention is at least 50 parts by weight per hundred parts of elastomer of the elastomer composition (phr).

Preferably, the content of highly saturated diene elastomer in the elastomer composition of use in the context of the present invention varies in a range extending from 70 to 100 phr or from 80 to 100 phr. More preferentially, it varies in a range extending from 90 to 100 phr.

When the elastomer composition does not consist exclusively of a highly saturated diene elastomer (100 phr), it comprises at least one other diene elastomer. This other elastomer is present in proportions of at most 50 phr (parts by weight per hundred parts of total elastomer), preferably of at most 20 phr or at most 10 phr.

This other diene elastomer can be any homopolymer of a conjugated or non-conjugated diene monomer having from 4 to 18 carbon atoms; or any copolymer of a conjugated or non-conjugated diene having from 4 to 18 carbon atoms and of at least one other monomer.

The other monomer may be an olefin other than ethylene, or a conjugated or non-conjugated diene.

Suitable conjugated dienes include conjugated dienes having from 4 to 12 carbon atoms, in particular 1,3-dienes. More specifically, particularly suitable conjugated dienes include: 1,3-butadiene, 2-methyl-1,3-butadiene, 2,3-di(C₁-C₅ alkyl)-1,3-butadienes, for instance 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene, 2,4-hexadiene.

Suitable olefins include vinylaromatic compounds having from 8 to 20 carbon atoms and aliphatic α-monoolefins having from 3 to 12 carbon atoms. Suitable vinylaromatic compounds include, for example: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

Suitable aliphatic α-monoolefins include in particular acyclic aliphatic α-monoolefins having from 3 to 18 carbon atoms.

This other diene elastomer may have any microstructure. It may be a block, random, sequential or microsequential elastomer, and may be prepared in emulsion or in solution. It may be coupled and/or star-branched, or else functionalized with a coupling and/or star-branching or functionalizing agent.

Preferentially, this other diene elastomer used in the invention is selected from the group of highly unsaturated diene elastomers consisting of polybutadienes (BRs), synthetic polyisoprenes (IRs), natural rubber (NR), butadiene copolymers, isoprene copolymers and mixtures of these elastomers. Such copolymers are more preferentially selected from the group consisting of butadiene/styrene copolymers (SBRs), isoprene/butadiene copolymers (BIRs), isoprene/styrene copolymers (SIRs) and isoprene/butadiene/styrene copolymers (SBIRs).

It is understood that this other diene elastomer may consist of a mixture of diene elastomers which differ from one another in terms of their microstructures, their macrostructures or by the presence of a function, by the nature or position of said function in the elastomer chain.

### Reinforcing Filler

The elastomer composition of use in the context of the present invention comprises a reinforcing filler, the reinforcing filler comprising at least one pyrolysis carbon black. Aside from the pyrolysis carbon black, the reinforcing filler can comprise one or more other reinforcing fillers.

Advantageously, the specific combination of at least one highly saturated diene elastomer as described above and at least one pyrolysis carbon black as described below makes it possible, surprisingly, to obtain an elastomer composition having a good stiffness/hysteresis (wear resistance/rolling resistance) balance.

The term “reinforcing filler” denotes any type of filler known for its abilities to reinforce an elastomer composition that can be used in particular for the manufacture of tyres, for example organic fillers such as virgin carbon black or pyrolysis carbon black, or inorganic fillers such as silica or alumina.

Aside from the pyrolysis carbon black, therefore, the elastomer composition can also comprise at least one second reinforcing filler other than the pyrolysis carbon black, this second reinforcing filler being selected from the group consisting of silicas, aluminas and virgin carbon blacks.

Those skilled in the art will know how to adjust the total content of reinforcing filler, including the pyrolysis carbon black, depending on the intended use of the elastomer composition.

In some embodiments, the content of reinforcing filler in the elastomer composition of use in the context of the invention is within a range extending from 25 to 85 phr, preferably from 30 to 75 phr, or from 35 to 75 phr.

Preferentially, the pyrolysis carbon black represents more than 30% by weight, more preferentially represents more than 50% by weight, more preferentially still represents more than 70% by weight, more preferentially represents more than 90% by weight, of the total weight of the reinforcing filler.

Thus, preferentially, the content of reinforcing filler in the elastomer composition of use in the context of the invention is within a range extending from 25 to 85 phr, the carbon black representing more than 30% by weight, more preferentially representing more than 50% by weight, more preferentially still representing more than 70% by weight, more preferentially representing more than 90% by weight, of the total weight of the reinforcing filler.

Thus, more preferentially, the content of reinforcing filler in the elastomer composition of use in the context of the invention comprising at least one pyrolysis carbon black is within a range extending from 30 to 75 phr, the carbon black representing more than 30% by weight, more preferentially representing more than 50% by weight, more preferentially still representing more than 70% by weight, more preferentially representing more than 90% by weight, of the total weight of the reinforcing filler.

In some embodiments, the reinforcing filler is solely pyrolysis carbon black. In some embodiments, the elastomer composition comprises from 25 to 85 phr, preferably from 30 to 75 phr, of reinforcing filler, the reinforcing filler being pyrolysis carbon black. It should thus be understood that, in this particular embodiment, the elastomer composition comprises the pyrolysis carbon black as the only reinforcing fillers (the elastomer composition therefore does not comprise any inorganic reinforcing fillers or other organic reinforcing fillers).

The reinforcing fillers may be as described below.

### Pyrolysis Carbon Black

The elastomer composition of use in the context of the invention comprises at least one pyrolysis carbon black as reinforcing filler.

Within the meaning of the present invention, the term “pyrolysis carbon black” means a carbon black resulting from a process for the pyrolysis of a material comprising at least a carbon-based polymer and a carbon black, hereinafter referred to as the material to be pyrolyzed, for example in the context of the recycling of such a material. The physical state in which the material to be pyrolyzed is provided is not important, whether it is in the form of a powder, granules, a strip, or any other form, in the crosslinked or noncrosslinked state.

Preferentially, the material to be pyrolyzed may be recovered from manufactured articles or from products generated during their manufacture/production (such as by-products or scrap); it being possible for these manufactured articles to be selected from the group consisting of pneumatic tyres, non-pneumatic tyres, industrial conveyor belts, transmission belts, rubber seals, rubber hoses, shoe soles and windscreen wipers. More preferentially still, the pyrolysis carbon black of use in the context of the present invention is a carbon black obtained from a pyrolysis process of which the material to be pyrolyzed is derived from manufactured articles selected from the group consisting of pneumatic tyres and non-pneumatic tyres.

In the context of the present invention, “pyrolysis” means any type of thermal decomposition in the absence of oxygen and in which the raw material is the material to be pyrolyzed as defined above. Pyrolysis carbon blacks thus differ from “industrial” and/or “ASTM-grade” carbon blacks, also referred to as virgin carbon blacks, in that the carbon-based raw material used for the pyrolysis is a material comprising at least a carbon-based polymer and a carbon black and not materials derived from petroleum cuts or derived from coal or else from oils of natural origin.

Pyrolysis carbon blacks which can be used in the context of the present invention thus differ from known carbon blacks such as industrial and/or ASTM-grade carbon blacks, in particular “furnace” carbon blacks, hereinafter referred to as “virgin carbon blacks”, in particular by a higher ash content.

Preferentially, the pyrolysis carbon black which can be used in the context of the present invention has an ash content ranging from 5% to 30% by weight, more preferentially ranging from 8% to 25% by weight, more preferentially still ranging from 10% to 22% by weight, relative to the total weight of the pyrolysis carbon black.

Preferentially, the pyrolysis carbon black which can be used in the context of the present invention has a sulfur content of greater than 2% by weight, preferably ranging from 2.5% to 5% by weight, relative to the total weight of the pyrolysis carbon black.

Preferentially, the pyrolysis carbon black which can be used in the context of the present invention has a zinc content of greater than or equal to 2% by weight, preferably ranging from 2.5% to 8% by weight, relative to the total weight of the pyrolysis carbon black.

Preferentially, the pyrolysis carbon black which can be used in the context of the present invention has an STSA specific surface area measured in accordance with Standard ASTM D 6556-2021 within a range extending from 20 to 200 m²/g, more preferentially extending from 30 to 90 m²/g.

Preferentially, the pyrolysis carbon black which can be used in the context of the present invention has a void volume measured in accordance with Standard ASTM D7854 (2018) and at a pressure of 50 MPa within a range extending from 30 to 60 ml/100 g, more preferentially extending from 35 to 55 ml/100 g.

The ash content is determined by calcination in platinum dishes in a muffle furnace at 825° C. according to the following protocol. A dish is identified in advance before each series of measurements and is tared to within 0.1 mg, and the mass is denoted by P0. 5 g of pyrolysis carbon black sample, weighed precisely to within 0.1 mg, are introduced into the dish; this mass is denoted by P1. The dish and its contents are pre-calcined using a Bunsen burner until smoke appears and the product ignites. Once combustion of the product is complete, the dish and its contents are introduced into a muffle furnace heated to 825° C. for 1 h. After 1 h, the dish is removed from the furnace and immediately introduced into a desiccator at ambient temperature. When the dish and the ashes have returned to ambient temperature, the dish is weighed again to obtain the mass P2. Finally, it is possible to obtain the ash content (% ash) using the formula below:

$$\% ash = \frac{P 2 - P 0}{P 1 - P 0} \times 100$$

The content of zinc in the pyrolysis carbon black is realized after calcination of the sample, then take-up of the ashes in an acidic medium and assay by ICP-AES (inductively coupled plasma atomic emission spectroscopy). The ashes are obtained by carrying out the protocol above. About exactly 100 mg of ashes is taken (test sample) and introduced into a PFA (perfluoroalkoxy) tube for a HotBlock hot plate. 8 ml of 37% concentrated hydrochloric acid, 3 ml of 65% concentrated nitric acid and 0.5 ml of 40% hydrofluoric acid are then added.

The tube is closed with its stopper and is heated at 130° C. for 2 h. After cooling, the contents are then transferred using ultrapure water into a 100 ml PTFE (polytetrafluoroethylene) volumetric flask already containing 2 g of boric acid (to neutralize the hydrofluoric acid). Ultrapure water is added up to the graduation mark. The solution obtained is diluted 100-fold, by taking 1 ml into a 100 ml PFTE flask already containing 8 ml of 37% concentrated hydrochloric acid, 3 ml of 65% concentrated nitric acid, 0.5 ml of 40% hydrofluoric acid and 2 g of boric acid. This diluted solution is then filtered on a 0.45 μm GHP syringe filter before being analysed by inductively coupled plasma atomic emission spectroscopy (ICP-AES). Prior to the analysis of the diluted solution, at least 5 standards are analysed by ICP-AES at zinc concentrations of 0, 0.5, 1, 2 and 5 mg/I. These standards were prepared in 100 ml volumetric flasks, by dilution of a commercial solution certified to a zinc concentration of 1 g/l.

These volumetric flasks already contain 8 ml of 37% concentrated hydrochloric acid, 3 ml of 65% concentrated nitric acid, 0.5 ml of 40% hydrofluoric acid and 2 g of boric acid. The standard solutions are analysed by ICP-AES at a wavelength of λZn=202.613 nm. For each standard concentration (c), the intensity of the zinc signal IZn is plotted on a graph IZn=f(c), which corresponds to the calibration straight line (of type y=ax+b). The solution of the sample (diluted solution) of unknown concentration is then measured under the same conditions as the standards. The measured intensity is linked to the concentration using the previously obtained calibration straight line. The concentration [c]ashes in % by mass is thus obtained directly by the software, since the test sample and the volume have been previously recorded.

The concentration of zinc in the pyrolysis black [c]black in % by mass is obtained by the following equation:

$${[ c ]}_{black} = {[ c ]}_{ash} * 100 * \% ash$$

The content of sulfur in the pyrolysis carbon blacks is determined using a LECO furnace. LECO sulfur analysers are designed to measure, in particular, the content of sulfur in organic and/or inorganic materials by combustion and nondispersive infrared detection. Before measuring the content of sulfur in the sample, the boats are cleaned and the furnace is calibrated. The boats for the LECO furnace are cleaned beforehand: this involves analysing the empty boat, under the same conditions as the samples. The calibration curve is prepared using a commercial standard called “BBOT” having a purity of greater than 99.99% and a guaranteed content of carbon (C), hydrogen (H), nitrogen (N), oxygen (O) and sulfur (S). This content is as follows: C %: 72.52; H %: 6.09; N %: 6.51; O %: 7.43 and S %: 7.44. About exactly 10 3, 20±3 and 40±3 mg of BBOT are weighed into a boat. The standard/boat assembly is introduced into the combustion furnace, regulated at 1350° C. under pure oxygen. The combination of the temperature of the furnace and the analysis flow rate causes the combustion of the sample and the release of sulfur and/or carbon in the form of SO₂(g). After a time of 20 s, oxygen starts to flow through the lance in order to accelerate the combustion of materials that are difficult to burn. The sulfur and/or the carbon, in the form of SO₂(g), are entrained by a stream of oxygen through the infrared detection cells.

The instrument software plots a straight line linking the mass of standard introduced and the observed response (area) on the detector. A calibration straight line is thus obtained. After carefully cleaning the sampling equipment, about exactly 80±5 mg of pyrolysis carbon black is weighed and introduced into a boat for the LECO furnace. The observed area of the SO₂ peak is linked to the concentration using the calibration straight line. Using the mass of sample introduced into the boat, the instrument software then calculates the % by mass of sulfur in the sample.

Pyrolysis carbon blacks are sold for example by BlackBear under the reference “BBCT30” or by Scandinavian Enviro Systems under the reference “P550”.

### Virgin Carbon Black

The elastomer composition of use in the context of the invention can additionally comprise a carbon black other than the pyrolysis carbon black, this carbon black also being referred to as “virgin carbon black” because it is not produced from materials that already comprise carbon black. The virgin carbon black is produced from materials derived from petroleum cuts or derived from coal or else from oils of natural origin.

Suitable virgin carbon blacks include all carbon blacks, particularly the carbon blacks conventionally used in tyres or their treads, in particular industrial carbon blacks, more specifically “furnace” carbon blacks.

Among the virgin carbon blacks, mention will more particularly be made of the reinforcing virgin carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks.

The virgin carbon blacks can be used in the isolated state, as available commercially, or in any other form, for example as support for some of the rubber additives used. The virgin carbon blacks might, for example, be already incorporated in the diene elastomer, in particular isoprene elastomer, in the form of a masterbatch (see, for example, applications WO 97/36724-A2 or WO 99/16600-A1).

### Reinforcing Inorganic Filler

The elastomer composition of use in the context of the invention can comprise a silica or an alumina (i.e. one or more silicas or aluminas), which are reinforcing inorganic fillers.

The term “reinforcing inorganic filler” should be understood here as meaning any inorganic or mineral filler, regardless of its colour and its origin (natural or synthetic), also known as “white” filler, “clear” filler or even “non-black” filler in contrast to carbon black, which is capable of reinforcing, by itself alone, without means other than an intermediate coupling agent, an elastomer composition intended for the manufacture of tyres. In a known manner, some reinforcing inorganic fillers can be characterized in particular by the presence of hydroxyl (—OH) groups at their surface.

Mineral fillers of the siliceous type, preferentially silica (SiO₂), or of the aluminous type, in particular alumina (Al₂O₃), are particularly suitable as reinforcing inorganic fillers. The silica used may be any reinforcing silica known to those skilled in the art, in particular any precipitated or fumed silica having a BET specific surface area and also a CTAB specific surface area both of less than 450 m²/g, preferably in a range extending from 30 to 400 m²/g, in particular from 60 to 300 m²/g.

Use may be made of any type of precipitated silica, in particular highly dispersible precipitated silicas (HDS, for “highly dispersible silica”). These precipitated silicas, which are or are not highly dispersible, are well known to those skilled in the art. Mention may be made, for example, of the silicas described in applications WO03/016215-A1 and WO03/016387-A1. Among the commercial HDS silicas, use may particularly be made of the Ultrasil® 5000GR and Ultrasil® 7000GR silicas from Evonik or the Zeosil® 1085GR, Zeosil® 1115 MP, Zeosil® 1165MP, Zeosil® Premium 200MP and Zeosil® HRS 1200 MP silicas from Solvay. Use may be made, as non-HDS silica, of the following commercial silicas: the Ultrasil® VN2GR and Ultrasil® VN3GR silicas from Evonik, the Zeosil® 175GR silica from Solvay or the Hi-Sil EZ120G(-D), Hi-Sil EZ160G(-D), Hi-Sil EZ200G(-D), Hi-Sil 243LD, Hi-Sil 210 and Hi-Sil HDP 320G silicas from PPG.

The BET specific surface area of the silica is determined in a known manner by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method—gas: nitrogen—degassing: 1 hour at 160° C.—relative pressure p/po range: 0.05 to 0.17). The CTAB specific surface area of the silica is determined in accordance with French Standard NF T 45-007 of November 1987 (method B).

Mention may also be made, as other examples of inorganic fillers capable of being used in the elastomer compositions, of mineral fillers of the aluminous type, in particular alumina (Al₂O₃), aluminium oxides, aluminium hydroxides, aluminosilicates, titanium oxides, silicon carbides or silicon nitrides, all of the reinforcing type as described, for example, in patent applications WO 99/28376-A2, WO 00/73372-A1, WO 02/053634-A1, WO2004/003067-A1, WO2004/056915-A2, U.S. Pat. No. 6,610,261-B1 and U.S. Pat. No. 6,747,087-B2. Mention may in particular be made of the aluminas Baikalox A125 or CR125 (Baikowski), APA-100RDX (Condea), Aluminoxid C (Evonik) or AKP-G015 (Sumitomo Chemicals).

The physical state in which the reinforcing inorganic filler is provided is not important, whether it is in the form of a powder, of micropearls, of granules or else of beads or any other appropriate densified form. Of course, the term “reinforcing inorganic filler” is also understood to mean mixtures of different reinforcing inorganic fillers, in particular of silicas as described above.

Those skilled in the art will understand that, as a replacement for the reinforcing inorganic filler described above, a reinforcing filler of another nature may be used, provided that this reinforcing filler of another nature is covered with an inorganic layer such as silica, or includes on its surface functional sites, in particular hydroxyl sites, requiring the use of a coupling agent to establish the bond between this reinforcing filler and the diene elastomer.

In order to couple the reinforcing inorganic filler to the highly saturated diene elastomer, use may be made, in a well-known manner, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the highly saturated diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the highly saturated diene elastomer.

Preferentially, the organosilanes are selected from the group consisting of organosilane polysulfides (symmetrical or asymmetrical), such as bis(3-triethoxysilylpropyl) tetrasulfide, abbreviated to TESPT, sold under the name Si69 by Evonik, or bis(triethoxysilylpropyl) disulfide, abbreviated to TESPD, sold under the name Si75 by Evonik, polyorganosiloxanes, mercaptosilanes, blocked mercaptosilanes, such as S-(3-(triethoxysilyl)propyl) octanethioate, sold by Momentive under the name NXT Silane. More preferentially, the organosilane is an organosilane polysulfide.

Those skilled in the art can find coupling agent examples in the following documents: WO 02/083782, WO 02/30939, WO 02/31041, WO 2007/061550, WO 2006/125532, WO 2006/125533, WO 2006/125534, U.S. Pat. No. 6,849,754, WO 99/09036, WO 2006/023815, WO 2007/098080, WO 2010/072685 and WO 2008/055986.

The content of coupling agent preferentially represents from 0.5% to 15% by weight relative to the amount of reinforcing inorganic filler, preferably from 4% to 12%, more preferably from 6% to 10%, by weight relative to the amount of reinforcing inorganic filler. Typically, the content of coupling agent is less than 20 phr, preferentially within a range extending from 6 to 17 phr, preferably from 8 to 15 phr. This content can easily be adjusted by those skilled in the art according to the content of reinforcing inorganic filler used in the elastomer composition.

The elastomer composition may also contain, in addition to the coupling agents, coupling activators, agents for covering the inorganic fillers or more generally processing aids which are capable, in a known manner, by virtue of an improvement in the dispersion of the filler in the rubber matrix and of a lowering in the viscosity of the compositions, of improving their ease of processing in the raw state, these processing aids being, for example, hydrolysable silanes such as alkylalkoxysilanes (in particular alkyltriethoxysilanes), polyols, polyethers (for example polyethylene glycols), primary, secondary or tertiary amines (for example trialkanolamines), hydroxylated or hydrolysable POSs, for example α,ω-dihydroxypolyorganosiloxanes (in particular α,ω-dihydroxypolydimethylsiloxanes).

### Other Organic Fillers

The elastomer composition of use in the context of the invention may comprise a reinforcing organic filler of functionalized polyvinyl type as described in applications WO 2006/069792-A1, WO 2006/069793-A1, WO 2008/003434-A1 and WO 2008/003435-A1.

### Crosslinking System

The elastomer composition of use in the context of the invention comprises a crosslinking system.

The crosslinking system can be any type of system known to those skilled in the art in the field of elastomer compositions for tyres. It can in particular be based on sulfur and/or on peroxide and/or on bismaleimides.

Preferentially, the crosslinking system is based on sulfur; it is then referred to as a vulcanization system.

The sulfur can be contributed in any form, in particular in the form of molecular sulfur or of a sulfur-donor.

The term “sulfur donor” is understood to mean any compound which releases sulfur atoms, combined or not combined in the form of a polysulfide chain, which are capable of being inserted into the polysulfide chains formed during the vulcanization and bridging the elastomer chains. The sulfur content in the elastomer composition is preferentially less than 2 phr, preferably between 0.3 and 1.5 phr.

Use may be made, as (primary or secondary) vulcanization accelerator, of any compound that is capable of acting as accelerator of the vulcanization of the diene elastomers in the presence of sulfur, in particular accelerators of the thiazole type and also derivatives thereof, accelerators of sulfenamide type as regards the primary accelerators, or accelerators of thiuram, dithiocarbamate, dithiophosphate, thiourea and xanthate type as regards the secondary accelerators. Guanidine is understood to mean any compound which contains the divalent radical —HN—C(═NH)—NH—. The guanidine is preferably diphenylguanidine. The vulcanization accelerator is used at a preferential content of between 0.3 and 5 phr, more preferentially between 0.5 and 2.5 phr.

Mention may in particular be made, as examples of primary accelerators, of sulfenamide compounds, such as N-cyclohexyl-2-benzothiazolesulfenamide (“CBS”), N,N-dicyclohexyl-2-benzothiazolesulfenamide (“DCBS”), N-tert-butyl-2-benzothiazolesulfenamide (“TBBS”) and the mixtures of these compounds. The primary accelerator is preferentially a sulfenamide, more preferentially N-cyclohexyl-2-benzothiazylsulfenamide.

Mention may in particular be made, as examples of secondary accelerators, of thiuram polysulfides, preferentially thiuram disulfides, such as tetraethylthiuram disulfide, tetrabutylthiuram disulfide (“TBTD”), tetrabenzylthiuram disulfide (“TBZTD”) and mixtures of these compounds. The secondary accelerator is preferentially a thiuram disulfide, more preferentially tetrabenzylthiuram disulfide.

The primary accelerator is preferably a sulfenamide. When the primary vulcanization accelerator is a sulfenamide, it is preferably N-cyclohexyl-2-benzothiazylsulfenamide.

The vulcanization accelerator is preferentially a mixture of a primary accelerator and of a secondary accelerator. The term “primary accelerator” denotes a single primary accelerator or a mixture of primary accelerators.

Similarly, the term “secondary accelerator” denotes a single secondary accelerator or a mixture of secondary accelerators. When the vulcanization accelerator is a mixture of a primary accelerator and of a secondary accelerator, the vulcanization accelerator is preferably a mixture of a sulfenamide and a thiuram disulfide, or a mixture of a sulfenamide, a thiuram disulfide and a guanidine, the sulfenamide preferentially being N-cyclohexyl-2-benzothiazylsulfenamide, the thiuram disulfide preferentially being tetrabenzylthiuram disulfide, the guanidine preferentially being diphenylguanidine.

In a known manner, the vulcanization system may also comprise vulcanization activators, for instance metal oxides such as zinc oxide or fatty acids such as stearic acid.

### Usual Additives and Processing Aids

The elastomer composition of use in the context of the invention may also comprise all or some of the usual additives and processing aids which are known to those skilled in the art and are customarily used in elastomer compositions for tyres, for instance plasticizers (such as plasticizing oils and/or plasticizing resins), non-reinforcing fillers, pigments, green tack promoting agents (i.e. tackifying agent), pro-oxidant metal salts, protective agents such as anti-ozone waxes, chemical anti-ozonants, antioxidants, anti-fatigue agents, reinforcing resins (as described, for example, in application WO 02/10269).

Preferentially, the content of plasticizer(s) in the elastomer composition of use in the context of the invention is within a range extending from 0 to 20 phr, more preferentially within a range extending from 0 to 10 phr.

### Manufacture of the Compositions

The elastomer composition of use in the context of the invention is manufactured in appropriate mixers using two successive preparation phases that are well known to those skilled in the art:
a first phase of thermomechanical working or kneading (“non-productive” phase), which can be carried out in a single thermomechanical step during which all the necessary constituents, in particular the highly saturate diene elastomer as defined above, the reinforcing filler(s) including the pyrolysis carbon black, and the various other optional additives, with the exception of the crosslinking system, are introduced into an appropriate mixer, such as a standard internal mixer (for example of ‘Banbury’ type). The reinforcing filler may be incorporated into the highly saturated diene elastomer in one or more portions while thermomechanically kneading. The non-productive phase is carried out at high temperature, up to a maximum temperature within a range extending from 110° C. to 200° C., for a period of time generally within a range extending from 2 to 10 minutes;
a second phase of mechanical working (“productive” phase), which is carried out in an external mixer, such as an open mill, after cooling the mixture obtained during the non-productive first phase down to a lower temperature, typically of less than 120° C., for example ranging from 40° C. to 100° C. The crosslinking system is then incorporated and the combined mixture is then mixed for a few minutes, for example from 5 to 15 min.

The final elastomer composition thus obtained is subsequently calendered, for example in the form of a sheet or slab, in particular for laboratory characterization, or else extruded in the form of a rubber semi-finished (or profiled) element which can be used, for example, as a tyre tread, particularly as a tread for a tyre for a vehicle carrying heavy loads, particularly a heavy-goods vehicle or a civil engineering vehicle.

The elastomer composition can be either in the raw state (before crosslinking or vulcanization) or in the cured state (after crosslinking or vulcanization), or can be a semi-finished product which can be used in a tyre.

The elastomer composition can be crosslinked in a manner known to those skilled in the art, for example at a temperature within a range extending from 130° C. to 200° C., preferably under pressure, for a sufficient time which can vary, for example, from 5 to 90 min.

### Rubber Articles

Another subject of the present invention relates to a rubber article comprising at least one elastomer composition as defined above.

The rubber article may be any type of article such as a hose, tubing, a gasket, an O-ring, a transmission belt, an engine support, an electric cable insulator, a shoe sole, a semi-finished article for pneumatic tyres, a semi-finished article for non-pneumatic tyres, a pneumatic tyre or a non-pneumatic tyre.

Preferentially, the rubber article is selected from the group consisting of semi-finished articles for pneumatic tyres, semi-finished articles for non-pneumatic tyres, pneumatic tyres and non-pneumatic tyres.

The semi-finished products for pneumatic tyres or non-pneumatic tyres are rubber products intended for the manufacture of pneumatic tyres or non-pneumatic tyres. This may be any type of rubber strip, such as in particular treads, underlayers, etc.

More preferentially, the elastomer composition as defined above of use in the context of the invention constitutes all or part of said semi-finished article.

Preferably, the semi-finished article for pneumatic tyres or non-pneumatic tyres is a tread.

In a known manner, the tread of a pneumatic or non-pneumatic tyre comprises a tread surface intended to be in contact with the ground when the pneumatic tyre or non-pneumatic tyre is rolling. The tread is provided with a tread pattern comprising in particular tread pattern elements or elementary blocks delimited by various grooves.

Advantageously, the elastomer composition as defined above of use in the context of the invention is present in the tread of the pneumatic tyre or non-pneumatic tyre, preferably in the radially outer part of the tread, intended to be in contact with the ground when the pneumatic tyre or non-pneumatic tyre is rolling. More preferentially still, the elastomer composition as defined above of use in the context of the invention constitutes all or part of the tread, particularly for pneumatic tyres or non-pneumatic tyres.

The term “pneumatic tyre” is intended to mean a tyre intended to form a cavity by engaging with a support element, for example a rim, this cavity being capable of being pressurized to a pressure greater than atmospheric pressure.

Conversely, a “non-pneumatic tyre” is a tyre which supports the load of a vehicle by means other than a pressurized inflation gas. Thus, a non-pneumatic tyre is a toroidal body consisting of at least one polymer material, intended to perform the function of a tyre but without being subjected to an inflation pressure. A non-pneumatic tyre may be solid or hollow. A hollow non-pneumatic tyre may contain air, but at atmospheric pressure, which is to say that it has no pneumatic stiffness afforded by an inflation gas at a pressure greater than atmospheric pressure. Non-pneumatic tyres are described, for example, in documents WO 03/018332 and FR 2 898 077.

The pneumatic or non-pneumatic tyres are intended in particular to equip vehicles of all types.

Preferentially, the rubber article according to the invention is a semi-finished article for a pneumatic tyre, preferably a tread, such as a tread particularly consisting entirely or partially of at least one elastomer composition as defined above. More preferentially still, the semi-finished article above is a semi-finished article for industrial vehicles such as heavy-goods vehicles, vans, agricultural vehicles, buses, underground trains, civil engineering vehicles, aircraft and other handling vehicles

More preferentially still, the rubber article according to the invention is a pneumatic tyre comprising at least one elastomer composition, in particular in the tread thereof, said elastomer composition constituting all or part of said tread. More preferentially still, the rubber article is a pneumatic tyre for industrial vehicles such as heavy-goods vehicles, vans, agricultural vehicles, buses, underground trains, civil engineering vehicles, aircraft and other handling vehicles The pneumatic tyre may be manufactured by any process well known to those skilled in the art.

Preferentially, the rubber article is a pneumatic or non-pneumatic tyre, the tread of which consists entirely or partially of at least one elastomer composition according to the invention.

The examples that follow are given by way of illustration but must in no way be considered to limit the present invention.

### EXAMPLES

### Measurement Method

### 1.1 Determination of the Microstructure of the Elastomers

The copolymers of ethylene and of 1,3-butadiene are characterized by ¹H and ¹³C NMR spectrometry. The NMR spectra are recorded on a Bruker Avance Ill HD 500 MHz spectrometer equipped with a BBI z-grad 5 mm “broad band” cryoprobe. The quantitative 1H NMR experiment uses a simple 30° pulse sequence and a repetition time of 5 seconds between each acquisition. 64 to 256 accumulations are carried out. The quantitative ¹³C NMR experiment uses a simple 30° pulse sequence with proton decoupling and a repetition time of 10 seconds between each acquisition. 1024 to 10 240 accumulations are carried out. ¹H/¹³C two-dimensional experiments are used for the purpose of determining the structure of the polymers. The determination of the microstructure of the copolymers is defined in the literature, according to the paper by Llauro et al., Macromolecules, 2001, 34, 6304-6311. The NMR measurements are carried out at 25° C. The copolymers are dissolved in a deuterated solvent (approximately 25 mg of elastomer in 1 ml), in general deuterated chloroform (CDCl₃).

### 1.2 Mooney Viscosity:

The Mooney viscosity is measured using an oscillating consistometer as described in Standard ASTM D1646 (1999). The measurement is carried out according to the following principle: the sample, analysed in the raw state (i.e., before curing), is moulded (shaped) in a cylindrical chamber heated to a given temperature (100° C.). After preheating for 1 minute, the rotor rotates within the test specimen at 2 revolutions/minute and the working torque for maintaining this movement is measured after rotating for 4 minutes. The Mooney viscosity (ML) is expressed in “Mooney units” (MU, with 1 MU=0.83 newton·metre).

### 1.3 Size Exclusion Chromatography (SEC/RI)

Size exclusion chromatography (SEC) makes it possible to break up polymer chains in a solvent based on their hydrodynamic volume. Like all chromatographic systems, the technique is based on the elution of a solute (the polymer) through a column containing a stationary phase. The system is composed, in this order, of: a solvent reservoir, a pump system, an injector, a set of columns and detectors. The measurement system is equipped with a Waters Alliance e2695 module and a Waters fRI410 refractometer.

The mobile phase is eluted at a flow rate of 1 ml/min. The polymer is dissolved in THF at a concentration of 1 g/l. A volume of 100 μl is injected through a set of 3 size exclusion chromatography columns from the bran AG/LENT (MIXED B LS). The columns are thermostatically maintained at 35° C. in an oven. The stationary phase of the columns is based on a polystyrene/divinylbenzene gel having a controlled porosity.

The polymer chains are separated based on the hydrodynamic volume that they occupy when they are dissolved in the solvent. The greater the volume they occupy, the less the pores of the columns are accessible to them, and the shorter their elution time. Detection is provided by a refractometer (RI) thermostatically maintained at 35° C. Each elution volume is associated with a mass via Moore calibration (calibrating against certified standards: polystyrene standards from Polymer Standard Service (Mainz)). The WATERS: EMPOWER software was used to acquire and analyse the data. It is thus possible to determine the number-average molar masses (Mn), the weight-average molar masses (Mw), and also the dispersity (Ð=Mw/Mn).

### 1.4 Dynamic Properties.

The dynamic properties are measured on a viscosity analyser (Metravib VA4000) according to Standard ASTM D 5992-96. The response of a sample of the vulcanized elastomer composition (cylindrical test specimen with a thickness of 4 mm and a cross section of 400 mm²), subjected to a simple alternating sinusoidal shear stress, at a frequency of 10 Hz and a temperature of 60° C., is recorded.

For the measurements of complex dynamic shear modulus (G*) and loss factor tan(delta), a strain amplitude sweep is carried out from 0.1% to 100% peak-to-peak (outward cycle), and then from 100% to 0.1% peak-to-peak (return cycle). For the return cycle, the maximum value of tan(delta) observed, denoted by tan(delta)max; and also the modulus G* at 50% strain, denoted by G*50%, are indicated.

The value of tan(delta)max is indicative of the hysteresis of the material and, in the present case, of the rolling resistance: the smaller the value of tan(delta)max, the better the rolling resistance. The G*25% values, measured at 60° C., are representative of the stiffness, that is to say of the resistance to deformation: the higher the value of G*25% at 60° C., the greater the stiffness of the material and thus the better the wear resistance.

All the values are given in base 100 with respect to a given control.

### 1.5 Tensile Tests

The tensile tests make it possible to determine the elasticity stresses and the properties at break. Unless otherwise indicated, they are carried out in accordance with the French standard NF T 46-002 (1988).

Processing the tensile recordings makes it possible in particular to plot the curve of modulus as a function of elongation. The modulus used here is the nominal (or apparent) secant modulus measured in first elongation, calculated by reducing to the initial cross section of the test specimen. The nominal secant modulus (or apparent stress, in MPa) at 300% elongation, denoted by MSA300, is measured in first elongation.

The breaking stresses (in MPa) and the elongations at break (in %) are measured at 60° C.±2° C. according to French standard NF T 46-002 (1988).

All the values are given in base 100 with respect to a given control.

A value greater than 100 indicates a value greater than that of the control.

### Synthesis of the Highly Saturated Diene Elastomer

The copolymer of ethylene and of 1,3-butadiene, elastomer E1, is synthesized according to the procedure described below.

All the reagents are obtained commercially except for the metallocene, which can be prepared according to the procedure described in the document WO 2007/054224.

The butyloctylmagnesium BOMAG (20% in heptane, C=0.88 mol·l⁻¹) originates from Chemtura and is transferred into and then stored in a Schlenk tube under an inert atmosphere. The ethylene, of N35 grade, originates from Air Liquide and is used without prior purification.

The ethylene and the 1,3-butadiene are polymerized according to a continuous process in solution in methylcyclohexane at 80° C. and 10 bar, in the presence of a catalytic system (195 μmol Nd per 100 g of monomers), the concentration by weight for feeding monomers into the reactor being 7%, the 1,3-butadiene/ethylene weight ratio being 0.79, the active Mg/Nd molar ratio being 2.7. The supplemental Mg to reach a ratio of 2.7 is supplied by adding BOMAG into the polymerization medium.

At the desired conversion (83%, 120 minutes) for achieving an Mn of approximately 160 000 g/mol, the polymerization is stopped at the line outlet using a solution of antioxidants in methylcyclohexane (0.8 phr of N-(1,3-dimethylbutyl)-N′-phenyl-p-phenylenediamine and 0.7 phr of 2,2′-methylenebis(4-methyl-6-tertbutylphenol); phr=parts by weight per hundred parts of elastomer). The copolymer is recovered by a steam distillation process known as “stripping” that is well known to those skilled in the art, and is then dried on an endless screw machine equipped with a single screw.

The copolymer contains 69% ethylene units, 23% butadiene units (1,2 units and 1,4 units, more than 80% of which are in the 1,4-trans form) and 8% cyclic units (1,2-cyclohexane sub-units). The transition temperature thereof is −43° C. (ΔT of 5° C., ΔT being the temperature difference between the start and end of the glass transition), the Mn thereof is 157 700 g/mol, and the ML (1+4) thereof at 100° C. is 69.

The catalytic system is a preformed catalytic system. It is prepared in methylcyclohexane from a metallocene, [Me₂Si(Flu)₂Nd(μ-BH₄)₂Li(THF)] at 0.0065 mol/1, a cocatalyst, butyloctylmagnesium (BOMAG), the BOMAG/Nd molar ratio of which is equal to 2.2, and a preformation monomer, 1,3-butadiene, the 1,3-butadiene/Nd molar ratio of which is equal to 90. The medium is heated at 80° C. over a period of 5 h. It is prepared according to a preparation method in accordance with section 11.1 of Patent Application WO 2017/093654 A1.

### Preparation of the Compositions

Introduced successively into an internal mixer with a volume of 3300 cm³ (final degree of filling: approximately 70% by volume), the initial vessel temperature of which is approximately 50° C., are the highly saturated diene elastomer, the reinforcing filler(s), where appropriate the hydrocarbon-based plasticizing resin, the secondary accelerators and also the various other ingredients, with the exception of the sulfur and the primary accelerator. Thermomechanical working (non-productive phase) is then carried out in one step, which lasts in total approximately 3 to 4 ml, until a maximum dropping temperature of 160° C. is reached. The mixture thus obtained is recovered, it is cooled and then the sulfur and the primary accelerator are incorporated on an external mixer (open mill) at 30° C., everything being mixed (productive phase) for 10 minutes.

The composition was crosslinked at a temperature of 140° C., under pressure, in a manner known to those skilled in the art.

The breakdown of the formulations of the compositions is given in Table 1.

The formulations of the prepared compositions are described in Table 1 (components and content—unless otherwise indicated, the contents are expressed in phr).

The properties in the cured state of the compositions prepared are also presented in Table 1.

TABLE 1
formulation of the various compositions,
and properties in the cured state

| | T0 | T1 | T2 | C1 | C2 | C3 |
|---|---|---|---|---|---|---|
| Elastomer (1) | 100.00 | 100.00 | 100.00 | 100.00 | 100.00 | 100.00 |
| Carbon black | 28.00 | 35.00 | 40.00 | (—) | (—) | (—) |
| (2) | | | | | | |
| Pyrolysis | (—) | (—) | (—) | 35.00 | 40.00 | 45.00 |
| carbon | | | | | | |
| black (3) | | | | | | |
| Paraffin | 1.00 | 1.00 | 1.00 | 1.00 | 1.00 | 1.00 |
| Antioxidant (4) | 2.00 | 2.00 | 2.00 | 2.00 | 2.00 | 2.00 |
| Stearic acid | 2.00 | 2.00 | 2.00 | 2.00 | 2.00 | 2.00 |
| ZnO | 2.50 | 2.50 | 2.50 | 2.50 | 2.50 | 2.50 |
| Primary | 0.50 | 0.50 | 0.50 | 0.50 | 0.50 | 0.50 |
| accelerator (5) | | | | | | |
| Secondary | 0.80 | 0.80 | 0.80 | 0.80 | 0.80 | 0.80 |
| accelerator (6) | | | | | | |
| Sulfur | 0.50 | 0.50 | 0.50 | 0.50 | 0.50 | 0.50 |

Properties in the cured state

| | | | | | | |
|---|---|---|---|---|---|---|
| Elongation at | 100 | 81 | 101 | 127 | 115 | 142 |
| break, | | | | | | |
| 60° C. (%) | | | | | | |
| Breaking | 100 | 90 | 143 | 83 | 88 | 117 |
| stress, 60° C. | | | | | | |
| (MPa) | | | | | | |
| MSA300 | 100 | 137 | 162 | 77 | 97 | 98 |
| G*50%, 60° C. | 100 | 119 | 175 | 132 | 145 | 149 |
| (MPa) | | | | | | |
| Tan(delta)max, | 100 | 107 | 108 | 68 | 69 | 77 |
| 60° C. | | | | | | |

(1) Ethylene/butadiene copolymer containing 69% ethylene units, 23% butadiene units (1,2 units and 1,4 units, more than 80% of which are in the 1,4-trans form) and 8% cyclic units (1,2-cyclohexane sub-units). The transition temperature thereof is −43° C. (ΔT of 5° C., ΔT being the temperature difference between the start and end of the glass transition), the Mn thereof is 157 700 g/mol, and the Mooney viscosity ML (1+4) thereof at 100° C. is 69.
(3) Conventional N234-grade carbon black according to standard D1765—the ash content of which is less than 0.7% by weight relative to the total weight of the carbon black, the sulfur content is less than 1.2% by weight relative to the total weight of carbon black, zinc as an impurity (of the order of ppm);
(4) Pyrolysis carbon black “P550” from Scandinavian Enviro Systems, the ash content of which is equal to 18.5% by weight relative to the total weight of the pyrolysis carbon black, the sulfur content is equal to 3% by weight relative to the total weight of the pyrolysis carbon black, the zinc content is equal to 4.5% by weight relative to the total weight of the pyrolysis carbon black; (4) 2,2,2-trimethyl-1,2-dihydroquinoline from Flexys;
(5) N-Cyclohexyl-2-benzothiazolesulfenamide from Flexsys;
(6) tetrabenzylthiuram disulfide from Flexsys (0.30 phr) and diphenylguanidine from Flexsys (0.50 phr).

The tests demonstrate an improvement in the stiffness/hysteresis balance, without notably adversely affecting strength, for the compositions in accordance with the invention (C1, C2 and C3) compared to the composition not in accordance with the invention (T0)).

According to Table 1, it is observed that an increase in the content of pyrolysis carbon black in a composition comprising an EBR elastomer (C1, C2 and C3) makes it possible to maintain a favourable stiffness/hysteresis balance without notably adversely affecting strength (MSA300).

Surprisingly, the compositions in accordance with the invention C1, C2 and C3 also have better properties of elongation at break compared to the compositions not in accordance with the invention.

1.-15. (canceled)

16. An elastomer composition based on:
at least one highly saturated diene elastomer, the highly saturated diene elastomer being a copolymer of ethylene and of a 1,3-diene containing ethylene units which represent at least 50 mol % of the monomer units of the copolymer;
a reinforcing filler comprising at least one pyrolysis carbon black; and
a crosslinking system.

17. The elastomer composition according to claim 16, wherein the highly saturated diene elastomer comprises at least 60 mol % of ethylene units.

18. The elastomer composition according to claim 16, wherein the highly saturated diene elastomer contains units of formula (I) or units of formula (II)

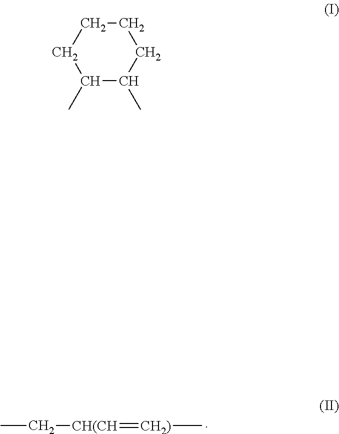

19. The elastomer composition according to claim 18, wherein the highly saturated diene elastomer comprises units of formula (I) at a molar content greater than 0 and less than 15%.

20. The elastomer composition according to claim 19, wherein the highly saturated diene elastomer is a copolymer of ethylene and of 1,3-butadiene.

21. The elastomer composition according to claim 16, wherein the pyrolysis carbon black has an ash content ranging from 5% to 30% by weight relative to a total weight of the pyrolysis carbon black.

22. The elastomer composition according to claim 16, wherein the pyrolysis carbon black has a sulfur content of greater than 2% by weight relative to a total weight of the pyrolysis carbon black.

23. The elastomer composition according to claim 16, wherein a content of reinforcing filler is within a range extending from 25 to 85 phr.

24. The elastomer composition according to claim 16, wherein the pyrolysis carbon black represents more than 30% by weight of a total weight of the reinforcing filler.

25. The elastomer composition according to claim 16, wherein the reinforcing filler additionally comprises at least one second reinforcing filler other than the pyrolysis carbon black, the at least one second reinforcing filler being selected from the group consisting of virgin carbon blacks, aluminas and silicas.

26. The elastomer composition according to claim 16, wherein a content of highly saturated diene elastomer is at least 50 phr.

27. The elastomer composition according to claim 16, wherein a content of highly saturated diene elastomer varies within a range extending from 50 to 100 phr.

28. A rubber article comprising the elastomer composition according to claim 16.

29. The rubber article according to claim 28, wherein the rubber article is a semi-finished article for a pneumatic tire.

30. The rubber article according to claim 28, wherein the rubber article is a pneumatic or non-pneumatic tire, a tread of which consists entirely or partially of the elastomer composition.

31. The elastomer composition according to claim 24, wherein the pyrolysis carbon black represents more than 50% by weight of the total weight of the reinforcing filler.

32. The elastomer composition according to claim 31, wherein the pyrolysis carbon black represents more than 70% by weight of the total weight of the reinforcing filler.

33. The elastomer composition according to claim 32, wherein the pyrolysis carbon black represents more than 90% by weight of the total weight of the reinforcing filler.

34. The rubber article according to claim 28, wherein the rubber article is selected from the group consisting of hoses, tubings, gaskets, O-rings, transmission belts, engine supports, electric cable insulators, footwear soles, semi-finished articles for pneumatic tires, semi-finished articles for non-pneumatic tires, non-pneumatic tires and pneumatic tires.

35. The rubber article according to claim 29, wherein the semi-finished article is a tread.
